(19) United States
(12) Patent Application Publication
(10) Pub. No.: US 2025/0146906 A1
(43) Pub. Date: May 8, 2025

(54) GEAR DEFECT DETECTION DEVICE AND GEAR DEFECT DETECTION METHOD

(71) Applicant: Mitsubishi Electric Corporation, Chiyoda-ku, Tokyo (JP)

(72) Inventors: Sachi ITAGAKI, Tokyo (JP); Masashi ASUKA, Tokyo (JP); Mototsugu KOZAKI, Tokyo (JP)

(73) Assignee: Mitsubishi Electric Corporation, Chiyoda-ku, Tokyo (JP)

(21) Appl. No.: 18/838,076

(22) PCT Filed: Apr. 4, 2022
(86) PCT No.: PCT/JP2022/017045

§ 371 Date: Aug. 13, 2024

(51) Int. Cl. G01M 13/021

(52) U.S. Cl. CPC G01M 13/021

(57) ABSTRACT

A gear defect detection device includes an acquisition unit that obtains a pulse signal from a sensor, where the pulse signal includes first signal sections and second signal sections alternating one after another, the first signal sections each represent a bottom portion of the gear, and the second signal sections each represent a top portion of the gear; and a calculation unit that determines, presence or absence of a defect of the gear on a basis of a ratio between the length of a first time period of a corresponding one of the first signal sections and the length of a second time period of a corresponding one of the second signal sections, and further determines the presence or absence of a defect of the gear using at least one of acceleration or jerk of an object that acts according to rotation of the gear.

### FIELD

The present disclosure relates to a gear defect detection device and a gear defect detection method each for detecting a defect of a gear.

### BACKGROUND

An operation is conventionally performed in which top and bottom portions of a gear rotated by a motor or the like are detected using a sensor, and a defect such as a chipped tooth of the rotating gear is detected on the basis of a signal representing the top and bottom portions output from the sensor. When the gear has teeth to have top and bottom portions thereof are equally spaced from each other, and the gear is rotated at a constant speed, the signal has a ratio of 1:1 between a width of a portion of the signal corresponding to a bottom portion of the gear and a width of a portion of the signal corresponding to a top portion of the gear. This enables a defect such as a chipped tooth of a gear to be detected by comparison of the ratio between the width of a portion of the signal corresponding to a bottom portion and the width of the portion of the signal corresponding to the top portion next thereto in the gear. However, in a situation of acceleration or deceleration of a gear, the signal does not have a ratio of 1:1 between the width of a portion of the signal corresponding to a bottom portion of the gear and the width of the portion of the signal corresponding to the top portion next thereto of the gear.

To address such problem, Patent Literature 1 discloses a technology for increasing accuracy of detection of a lost tooth of a gear by changing a lost tooth determination value depending on the rotation status of the gear, i.e., whether the gear is in an acceleration state or in a deceleration state.

### CITATION LIST

### Patent Literature

Patent Literature 1: Japanese Patent Application Laid-open No. 2017-48684

### SUMMARY OF INVENTION

### Problem to be solved by the Invention

However, the foregoing conventional technology assumes that the gear subjected to a chipped tooth is a crank rotor, which rotates integrally with a crankshaft, in which case the outer circumference of the crank rotor has a portion in which teeth are successively disposed at predetermined intervals and a portion in which no teeth are provided in advance. That is, the gear monitored for a defect is a specific type of gear. This presents a problem in undetectability of a defect of a typical gear having teeth being successively disposed at predetermined intervals on the entire outer circumference thereof.

The present disclosure has been made in view of the foregoing, and it is an object of the present disclosure to provide a gear defect detection device capable of increasing accuracy of detection of a defect of a gear that is rotating.

### Means to Solve the Problem

In order to solve the above problems and to achieve the object, a gear defect detection device according to the present disclosure includes: an acquisition unit to obtain a pulse signal from a sensor for detecting top and bottom portions of a gear, the pulse signal including first signal sections and second signal sections alternating one after another, the first signal sections each representing a bottom portion of the gear, the second signal sections each representing a top portion of the gear; and a calculation unit to determine, using the pulse signal, presence or absence of a defect of the gear on a basis of a ratio between a length of a first time period of a corresponding one of the first signal sections and a length of a second time period of a corresponding one of the second signal sections, and to further determine the presence or absence of a defect of the gear using at least one of acceleration or jerk of an object that acts according to rotation of the gear in the corresponding one of the first signal sections and in the corresponding one of the second signal sections.

### Effects of the Invention

A gear defect detection device of the present disclosure provides an advantage in capability of increasing accuracy of detection of a defect of a gear that is rotating.

### BRIEF DESCRIPTION OF DRAWINGS

FIG. 1 is a diagram illustrating an example configuration of a gear defect detection device according to a first embodiment.

FIG. 2 is a diagram illustrating a pulse signal output from a sensor according to the first embodiment.

FIG. 3 is a first diagram illustrating a pulse signal output from the sensor according to the first embodiment when a gear has a defect.

FIG. 4 is a second diagram illustrating a pulse signal output from the sensor according to the first embodiment when the gear has a defect.

FIG. 5 is a flowchart illustrating an operation of the gear defect detection device according to the first embodiment.

FIG. 6 is a diagram illustrating the length of time period of each signal section measured by a calculation unit of the gear defect detection device according to the first embodiment.

FIG. 7 is a diagram illustrating the length of time period of each signal section when the gear is rotating with acceleration, measured by the calculation unit of the gear defect detection device according to the first embodiment.

FIG. 8 is a diagram illustrating the length of time period of each signal section when the gear is rotating with deceleration, measured by the calculation unit of the gear defect detection device according to the first embodiment.

FIG. 9 is a diagram illustrating an acceleration of a railroad vehicle in each signal section calculated by the calculation unit of the gear defect detection device according to the first embodiment.

FIG. 10 is a diagram illustrating a jerk of the railroad vehicle in each signal section calculated by the calculation unit of the gear defect detection device according to the first embodiment.

FIG. 11 is a diagram illustrating an example of configuration of a processing circuitry of the gear defect detection device according to the first embodiment when the processing circuitry is implemented by a processor and a memory.

FIG. 12 is a diagram illustrating an example of configuration of the processing circuitry of the gear defect detection device according to the first embodiment when the processing circuitry includes a dedicated hardware element.

FIG. 13 is a first flowchart illustrating an operation of the gear defect detection device according to a second embodiment.

FIG. 14 is a second flowchart illustrating an operation of the gear defect detection device according to the second embodiment.

### DESCRIPTION OF EMBODIMENTS

A gear defect detection device and a gear defect detection method according to embodiments of the present disclosure will be described in detail below with reference to the drawings.

### First Embodiment

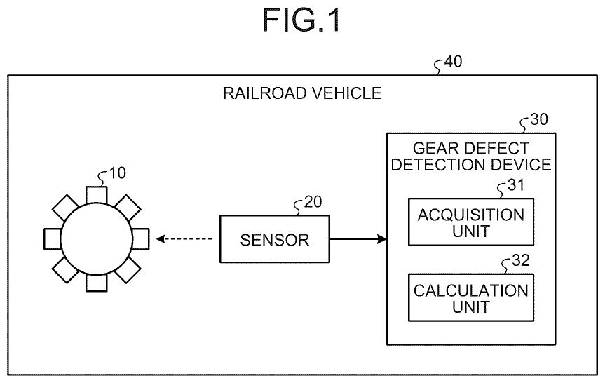

FIG. 1 is a diagram illustrating an example configuration of a gear defect detection device 30 according to a first embodiment. The gear defect detection device 30 is a device for detecting a defect of a gear 10 that is rotating. The gear defect detection device 30 is installed in a railroad vehicle 40. In addition, the gear defect detection device 30 is connected to a sensor 20. The gear defect detection device 30 and the sensor 20 may be connected to each other via wire or wirelessly.

The gear 10 is a component provided in the railroad vehicle 40. The gear 10 is monitored by the sensor 20, and is monitored by the gear defect detection device 30 for a defect. In the present embodiment, the gear 10 rotates in conjunction with rotation of an axle of wheels (not illustrated) of the railroad vehicle 40. That is, the gear 10 is provided at a position where the rotating speed thereof varies according to the speed of the railroad vehicle 40.

The sensor 20 detects top and bottom portions of the gear 10. The sensor 20 generates a pulse signal including first signal sections and second signal sections alternating one after another as a result of detection of the top and bottom portions of the gear 10, and outputs the pulse signal, where the first signal sections each represent a bottom portion of the gear 10, and the second signal sections each represent a top portion of the gear 10. Note that the sensor 20 may detect top and bottom portions of the gear 10 using a typical detection method, e.g., a method similar to the method used by the gear teeth detection unit described in Patent Literature 1.

The gear defect detection device 30 includes an acquisition unit 31 and a calculation unit 32. The acquisition unit 31 obtains the foregoing pulse signal from the sensor 20. The calculation unit 32 determines presence or absence of a defect of the gear 10 on the basis of a ratio between the length of a first time period of a corresponding one of the first signal sections and the length of a second time period of a corresponding one of the second signal sections, using the pulse signal obtained by the acquisition unit 31. The calculation unit 32 further determines the presence or absence of a defect of the gear 10 using at least one of acceleration and jerk of an object that acts according to rotation of the gear 10 in the first signal section and in the second signal section. In the present embodiment, the term “object that acts according to rotation of the gear 10” refers to the railroad vehicle 40 or wheels of the railroad vehicle 40. The following description assumes that the object that acts according to rotation of the gear 10 is the railroad vehicle 40.

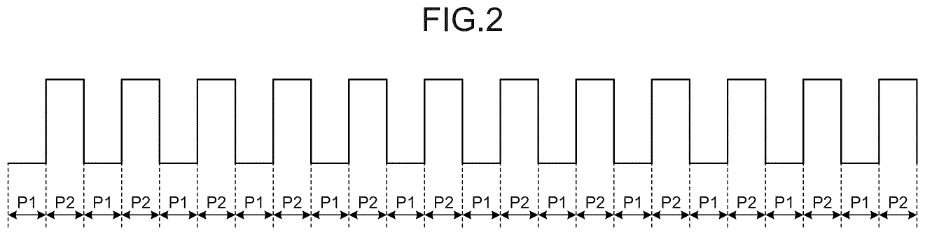

The pulse signal output from the sensor 20 will next be described. FIG. 2 is a diagram illustrating the pulse signal output from the sensor 20 according to the first embodiment. In FIG. 2, the sections designated by P1 are each the aforementioned first signal section, and the sections designated by P2 are each the aforementioned second signal section. Note that a notation may be used in which the sections designated by P1 are each the second signal section and the sections designated by P2 are each the first signal section. In a typical gear 10, the sections each corresponding to a bottom portion and the sections each corresponding to a top portion of the gear 10 are equally spaced from each other. Accordingly, when the gear 10 is rotating at a constant speed, the first signal section and the second signal section have a same length in time, and are equally spaced from each other.

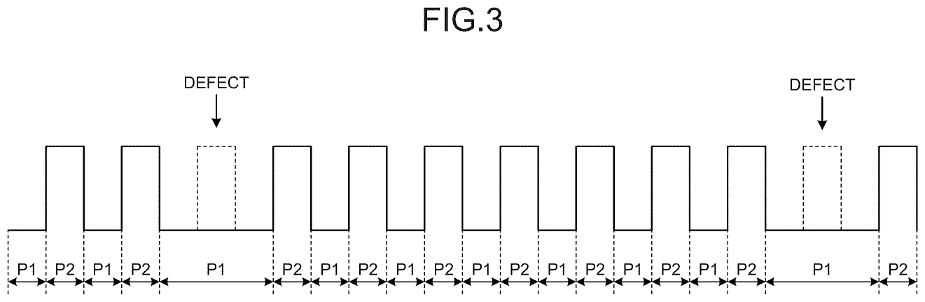

FIG. 3 is a first diagram illustrating a pulse signal output from the sensor 20 according to the first embodiment when the gear 10 has a defect. For example, when a defect occurs such as chipping of a part of one tooth of the gear 10, the portion to be otherwise detected as one of the second signal sections is lost, thereby causing an applicable one of the first signal sections to continue as illustrated in FIG. 3. In this case, the sensor 20 periodically outputs a pulse signal including a portion where the applicable one of the first signal sections continues as illustrated in FIG. 3.

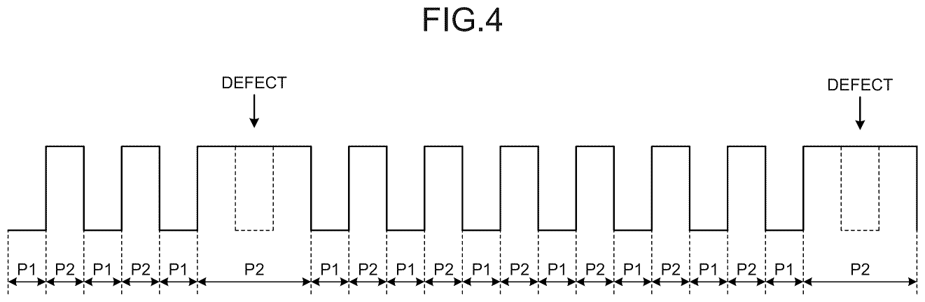

FIG. 4 is a second diagram illustrating a pulse signal output from the sensor 20 according to the first embodiment when the gear 10 has a defect. For example, when a defect occurs such as sticking of a chip between teeth adjacent to each other of the gear 10, the portion to be otherwise detected as one of the first signal sections is lost, thereby causing an applicable one of the second signal sections to continue as illustrated in FIG. 4. In this case, the sensor 20 periodically outputs a pulse signal including a portion where the applicable one of the second signal sections continues as illustrated in FIG. 4.

FIGS. 3 and 4 illustrate examples of the pulse signal output from the sensor 20 when a defect has actually occurred in the gear 10. What is more, the sensor 20 will one-time output a pulse signal indicating a defect of the gear 10 also when a bottom portion or a top portion of the gear 10 has failed to be detected for some reason. A conceivable method for preventing such a false detection is to avoid high sensitivity of the sensor 20. In this case, however, the sensor 20 may overlook a defect of the gear 10 that has actually occurred. Thus, in the present embodiment, the gear defect detection device 30 uses multiple detection methods to detect a defect of the gear 10. This enables the gear defect detection device 30 to reduce or prevent a false detection and to increase accuracy of detection of a defect of the gear 10 that is rotating, in detection of a defect of the gear 10. A specific operation of the gear defect detection device 30 will next be described.

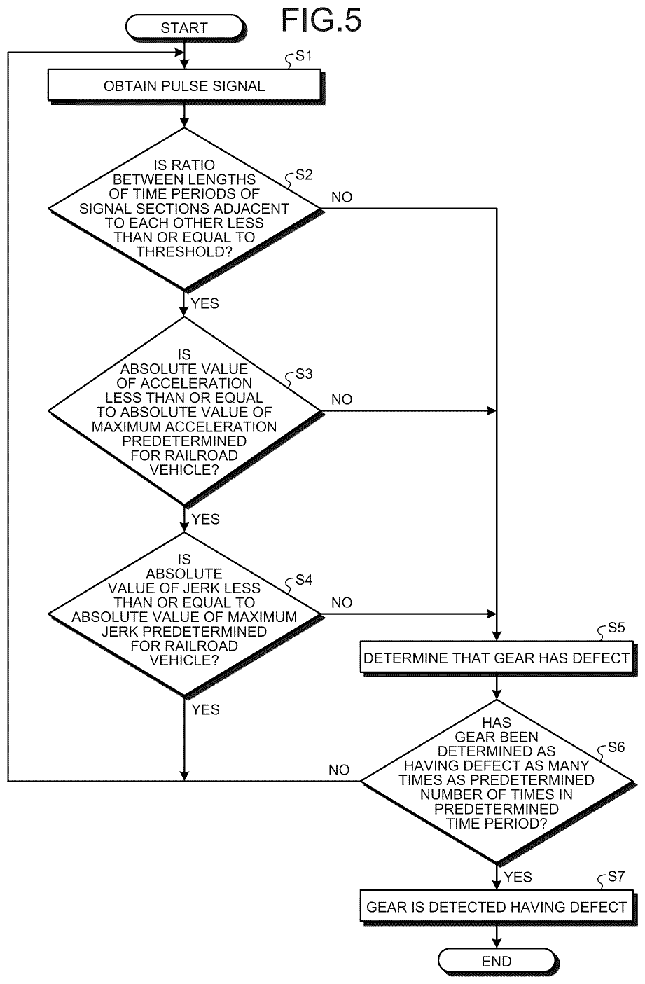

FIG. 5 is a flowchart illustrating an operation of the gear defect detection device 30 according to the first embodiment. In the gear defect detection device 30, the acquisition unit 31 obtains a pulse signal from the sensor 20 (step S1).

The calculation unit 32 determines whether the ratio between the lengths of time periods of respective signal sections adjacent to each other is less than or equal to a predetermined threshold, using the pulse signal obtained by the acquisition unit 31 from the sensor 20 (step S2). That is, the calculation unit 32 performs a first determination to determine the presence or absence of a defect of the gear 10 on the basis of the ratio between the length of the first time period of the first signal section and the length of the second time period of the second signal section. In this respect, the ratio to be compared with the threshold, i.e., the ratio between the length of the first time period of the first signal section and the length of the second time period of the second signal section, is a value calculated using the longer length of time period as the numerator and using the shorter length of time period as the denominator, of the length of the first time period of the first signal section and the length of the second time period of the second signal section. That is, the ratio between the length of the first time period of the first signal section and the length of the second time period of the second signal section is greater than or equal to 1.

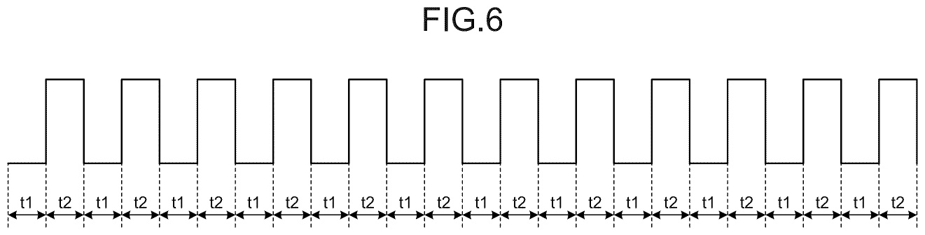

The calculation unit 32 measures the length of time period of each of the signal sections included in the pulse signal. FIG. 6 is a diagram illustrating the length of time period of each of the signal sections measured by the calculation unit 32 of the gear defect detection device 30 according to the first embodiment. In FIG. 6, t1 denotes the first time period corresponding to each of the first signal sections, and t2 denotes the second time period corresponding to each of the second signal sections. The pulse signal output from the sensor 20 includes the first signal sections and the second signal sections equally spaced from each other as described above when the gear 10 is rotating at a constant speed. That is, the lengths of time periods of the first signal sections and the lengths of time periods of the second signal sections are the same. Meanwhile, when the gear 10 is accelerating or decelerating, the signal sections have different lengths of time period.

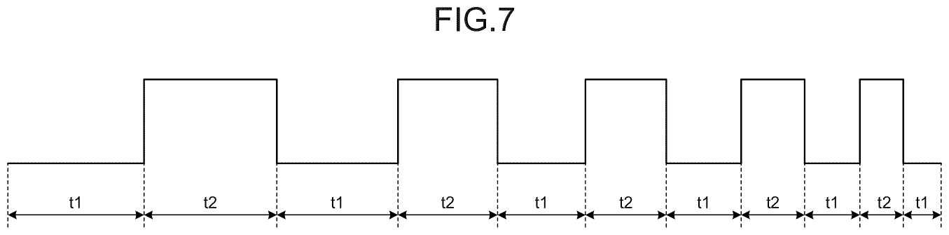

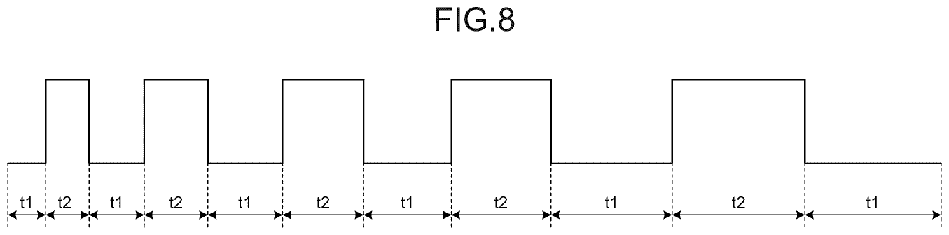

FIG. 7 is a diagram illustrating the length of time period of each of the signal sections when the gear 10 is rotating with acceleration, measured by the calculation unit 32 of the gear defect detection device 30 according to the first embodiment. FIG. 8 is a diagram illustrating the length of time period of each of the signal sections when the gear 10 is rotating with deceleration, measured by the calculation unit 32 of the gear defect detection device 30 according to the first embodiment. As described above, the sections each corresponding to a bottom portion and the sections each corresponding to a top portion of the gear 10 are equally spaced from each other, and the gear 10 rotates in conjunction with rotation of an axle of wheels of the railroad vehicle 40, meaning that the railroad vehicle 40 travels a same travel distance in association with one bottom portion of the gear 10 and one top portion of the gear 10. Thus, when the railroad vehicle 40 is running with acceleration, that is, when the gear 10 is rotating with acceleration, the pulse signal output from the sensor 20 has signal sections whose lengths of time periods gradually decrease as illustrated in FIG. 7. Alternatively, when the railroad vehicle 40 is running with deceleration, that is, when the gear 10 is rotating with deceleration, the pulse signal output from the sensor 20 has signal sections whose lengths of time periods gradually increase as illustrated in FIG. 8.

As such, in situations as those illustrated in FIGS. 7 and 8, the ratio between the length of the first time period of the first signal section and the length of the second time period of the second signal section is not 1. On the other hand, when a defect occurs such as chipping of a tooth of the gear 10 or sticking of a chip between teeth adjacent to each other of the gear 10 as illustrated in FIGS. 3 and 4, the signal section corresponding to the time of defect detection has a length of time period three times the length of time period of a signal section at the time of constant-speed rotation. Accordingly, when the ratio between the lengths of time periods of respective signal sections adjacent to each other calculated using the shorter length of time period of the signal section as the denominator is less than or equal to a predetermined threshold of 1.5 (step S2: Yes), the calculation unit 32 determines that the gear 10 has no defect, and causes the process to proceed to step S3. When the ratio between the lengths of time periods of respective signal sections adjacent to each other calculated using the shorter length of time period of the signal section as the denominator is greater than the predetermined threshold of 1.5 (step S2: No), the calculation unit 32 determines that the gear 10 has a defect such as the defect illustrated in FIG. 3 or 4 (step S5). Note that the threshold of 1.5 is merely by way of example, and the threshold is not limited to this value. The threshold can be determined by maintenance personnel of the railroad company operating the railroad vehicle 40 or the like, taking into account the acceleration expected for the railroad vehicle 40, the number of teeth of the gear 10, and/or the like.

Next, the calculation unit 32 determines whether the absolute value of an acceleration obtained by calculation is less than or equal to the absolute value of a maximum acceleration predetermined for the railroad vehicle 40 (step S3). The calculation unit 32 calculates a first speed of the railroad vehicle 40 in the first signal section from the length of the first time period, and calculates a second speed of the railroad vehicle 40 in the second signal section from the length of the second time period. As described above, the railroad vehicle 40 travels a same travel distance in association with one bottom portion of the gear 10 and one top portion of the gear 10. This enables the calculation unit 32 to calculate the speed of the railroad vehicle 40 in each of the signal sections by dividing the travel distance traveled by the railroad vehicle 40 in association with one bottom or top portion of the gear 10, by the length of time period of an applicable one of the signal sections obtained in the operation at step S2. The calculation unit 32 calculates a first acceleration of the railroad vehicle 40 in the first signal section, and calculates a second acceleration of the railroad vehicle 40 in the second signal section, where the first acceleration is a change rate of the first speed in the first signal section, and the second acceleration is a change rate of the second speed in the second signal section. The calculation unit 32 then performs a second determination to determine the presence or absence of a defect of the gear 10 by comparison of the absolute value of the first acceleration and the absolute value of the second acceleration each with the absolute value of the maximum acceleration predetermined for the railroad vehicle 40.

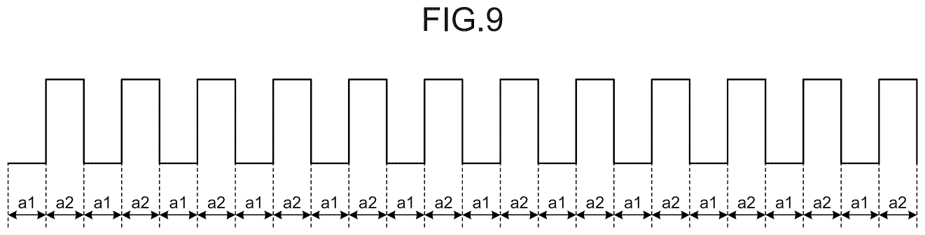

FIG. 9 is a diagram illustrating the acceleration of the railroad vehicle 40 in each of the signal sections calculated by the calculation unit 32 of the gear defect detection device 30 according to the first embodiment. In FIG. 9, a1 denotes the first acceleration corresponding to each of the first signal sections, and a2 denotes the second acceleration corresponding to each of the second signal sections. Note that when the railroad vehicle 40 is decelerating, the acceleration has a negative value. The calculation unit 32 can calculate the first acceleration by, but not limited to, differential of the first speed, and can calculate the second acceleration by, but not limited to, differential of the second speed. The calculation unit 32 can calculate as many values of acceleration as the number of the signal sections by calculating an acceleration for two signal sections adjacent to each other using the lengths of time periods and the speeds for the two signal sections, and shifting one by one the combination of the signal sections.

When the absolute value of the acceleration obtained by calculation is less than or equal to the absolute value of the maximum acceleration predetermined for the railroad vehicle 40 (step S3: Yes), the calculation unit 32 determines that the gear 10 has no defect, and causes the process to proceed to step S4. When the absolute value of the acceleration obtained by calculation is greater than the absolute value of the maximum acceleration predetermined for the railroad vehicle 40 (step S3: No), the calculation unit 32 determines that the gear 10 has a defect such as the defect illustrated in FIG. 3 or 4 (step S5). Note that when the maximum acceleration predetermined for the railroad vehicle 40 has different absolute values for a positive acceleration and for a negative acceleration, the calculation unit 32 may modify the absolute value of the maximum acceleration for use in the comparison to have values different between when the first acceleration or the second acceleration obtained by calculation has a positive value and has a negative value.

Next, the calculation unit 32 determines whether the absolute value of a jerk obtained by calculation is less than or equal to the absolute value of a maximum jerk predetermined for the railroad vehicle 40 (step S4). The calculation unit 32 calculates a first jerk of the railroad vehicle 40 in the first signal section, and calculates a second jerk of the railroad vehicle 40 in the second signal section, where the first jerk is a change rate of the first acceleration in the first signal section, and the second jerk is a change rate of the second acceleration in the second signal section. The calculation unit 32 then performs a third determination to determine the presence or absence of a defect of the gear 10 by comparison of the absolute value of the first jerk and the absolute value of the second jerk each with the absolute value of the maximum jerk predetermined for the railroad vehicle 40.

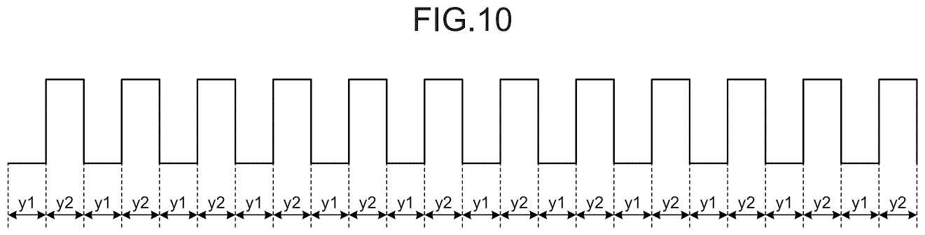

FIG. 10 is a diagram illustrating the jerk of the railroad vehicle 40 in each of the signal sections calculated by the calculation unit 32 of the gear defect detection device 30 according to the first embodiment. In FIG. 10, y1 denotes the first jerk corresponding to each of the first signal sections, and y2 denotes the second jerk corresponding to each of the second signal sections. Note that when the acceleration of the railroad vehicle 40 is decreasing over time, the jerk has a negative value. The calculation unit 32 can calculate the first jerk by, but not limited to, differential of the first acceleration, and can calculate the second jerk by, but not limited to, differential of the second acceleration. The calculation unit 32 can calculate as many values of jerk as the number of the signal sections by calculating a jerk for two signal sections adjacent to each other using the lengths of time periods and the acceleration values for the two signal sections, and shifting one by one the combination of the signal sections.

When the absolute value of the jerk obtained by calculation is less than or equal to the absolute value of the maximum jerk predetermined for the railroad vehicle 40 (step S4: Yes), the calculation unit 32 determines that the gear 10 has no defect, and causes the process to return to step S1 to repeat the foregoing operation. When the absolute value of the jerk obtained by calculation is greater than the absolute value of the maximum jerk predetermined for the railroad vehicle 40 (step S4: No), the calculation unit 32 determines that the gear 10 has a defect such as the defect illustrated in FIG. 3 or 4 (step S5). Note that when the maximum jerk predetermined for the railroad vehicle 40 has different absolute values for a positive jerk and for a negative jerk, the calculation unit 32 may modify the absolute value of the maximum jerk for use in the comparison to have values different between when the first jerk or the second jerk obtained by calculation has a positive value and has a negative value.

After determining that the gear 10 has a defect at step S5, the calculation unit 32 determines whether the calculation unit 32 has determined that the gear 10 has a defect as many times as a predetermined number of times in a predetermined time period (step S6). In the present embodiment, the calculation unit 32 determines whether the gear 10 has a defect, using multiple determination methods. This operation is more likely to result in a determination that the gear 10 has a defect than when it is determined whether the gear 10 has a defect using a single determination method. Meanwhile, this operation is also more likely to cause a false detection.

As such, when the calculation unit 32 has not determined that the gear 10 has a defect as many times as the predetermined number of times, e.g., three times, in a predetermined time period, i.e., in a certain time period (step S6: No), the calculation unit 32 causes the process to return to step S1 to repeat the foregoing operation. When the calculation unit 32 has determined that the gear 10 has a defect as many times as the predetermined number of times, e.g., three times, in a predetermined time period, i.e., in a certain time period (step S6: Yes), the calculation unit 32 determines that the gear 10 actually has a defect, and that the gear 10 has been detected having a defect (step S7). In this case, the calculation unit 32, for example, notifies the driver of the railroad vehicle 40 and/or the like of the detection of a defect of the gear 10. The calculation unit 32 may perform an emergency brake operation of the railroad vehicle 40 in addition to notifying the driver of the railroad vehicle 40 and/or the like of the detection of a defect of the gear 10.

Note that the predetermined number of times to be referred to at step S6 is not limited to three times, but may be two times or four or more times. In addition, the calculation unit 32 may count the number of times to be referred to at step S6 of determining that the gear 10 has a defect, for each of the determination methods used at steps S2, S3, and S4, or irrespective of the determination methods used at steps S2, S3, and S4. Thus, when the calculation unit 32 has determined that the gear 10 has a defect using any determination method as many times as a predetermined number of times in a predetermined time period, the calculation unit 32 determines that the gear 10 has been detected having a defect.

Although the present embodiment has been described in which the gear defect detection device 30 determines whether the gear 10 has a defect using three determination methods at steps S2, S3, and S4, it is expected that when the gear 10 actually has a defect, the defect of the gear 10 can be detected by a first determination method performed at step S2 in many cases. The case where the calculation unit 32 is unable to determine that the gear 10 has a defect by the first determination method at step S2, but can determine that the gear 10 has a defect by a second determination method at step S3 is, for example, a case where the railroad vehicle 40 was running at a low speed. The second determination method performed at step S3 is to detect a defect of the gear 10 when the speed has rapidly changed, that is, the acceleration has changed, to exceed a reference value while the railroad vehicle 40 was running at a low speed. By performing the second determination method at step S3, the calculation unit 32 is capable of detecting a situation where, for example, the railroad vehicle 40 was running at 4.0 km/h, and the speed changes to 8.0 km/h in a next signal section of the pulse signal.

In addition, the case where the calculation unit 32 is unable to determine that the gear 10 has a defect by neither the first determination method at step S2 nor the second determination method at step S3, but can determine that the gear 10 has a defect by a third determination method at step S4 is, for example, a case where the railroad vehicle 40 was running at a lower speed than the speed expected at step S3. The third determination method performed at step S4 is to detect a defect of the gear 10 when the acceleration has greatly changed while the railroad vehicle 40 was running at a lower speed than the speed expected at step S3. By performing the third determination method at step S4, the calculation unit 32 is capable of detecting a situation where the acceleration greatly changes, in which, for example, the railroad vehicle 40 was running at 2.0 km/h, the speed changes at a rate of acceleration of 2.0 km/h in a next signal section of the pulse signal, and the speed further changes at a rate of acceleration of −2.0 km/h in the signal section immediately after that next signal section of the pulse signal.

A hardware configuration of the gear defect detection device 30 according to the first embodiment will next be described. In the gear defect detection device 30, the acquisition unit 31 is an interface capable of obtaining a pulse signal from the sensor 20. The calculation unit 32 is implemented in a processing circuitry. The processing circuitry may include a memory storing a program and a processor that executes the program stored in the memory, or may be a dedicated hardware element. The processing circuitry is also referred to as control circuit.

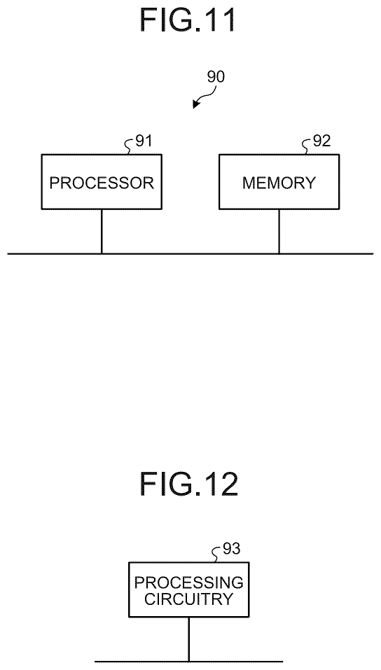

FIG. 11 is a diagram illustrating an example of configuration of a processing circuitry 90 when the processing circuitry of the gear defect detection device 30 according to the first embodiment is implemented by a processor 91 and a memory 92. The processing circuitry 90 illustrated in FIG. 11 is a control circuit, and includes the processor 91 and the memory 92. When the processing circuitry 90 includes the processor 91 and the memory 92, each functionality of the processing circuitry 90 is implemented in software, firmware, or a combination of software and firmware. The software or firmware is described in the form of a program, and is stored in the memory 92. The processing circuitry 90 provides each functionality in such a manner that the processor 91 reads and executes a program stored in the memory 92. That is, the processing circuitry 90 includes the memory 92 for storing a program that causes processing of the gear defect detection device 30 to be performed. It can also be said that this program is a program for causing the gear defect detection device 30 to perform each functionality that is to be provided by the processing circuitry 90. This program may be provided using a storage medium storing the program, or using other means such as a communication medium.

The foregoing program can also be said to be a program that causes the gear defect detection device 30 to perform a first step in which the acquisition unit 31 obtains a pulse signal from the sensor 20 for detecting top and bottom portions of the gear 10, where the pulse signal includes first signal sections and second signal sections alternating one after another, the first signal sections each represent a bottom portion of the gear 10, and the second signal sections each represent a top portion of the gear 10; and a second step in which the calculation unit 32 determines, using the pulse signal, presence or absence of a defect of the gear 10 on the basis of a ratio between the length of a first time period of a corresponding one of the first signal sections and the length of a second time period of a corresponding one of the second signal sections, and further determines the presence or absence of a defect of the gear 10 using at least one of acceleration and jerk of an object that acts according to rotation of the gear 10 in the corresponding one of the first signal sections and in the corresponding one of the second signal sections.

In this respect, the processor 91 is, for example, a central processing unit (CPU), a processing unit, a computing unit, a microprocessor, a microcomputer, a digital signal processor (DSP), or the like. In addition, the memory 92 is, for example, a non-volatile or volatile semiconductor memory such as a random access memory (RAM), a read-only memory (ROM), a flash memory, an erasable programmable ROM (EPROM), or an electrically erasable programmable ROM (EEPROM) (registered trademark); a magnetic disk, a flexible disk, an optical disk, a compact disc, a MiniDisc, a digital versatile disc (DVD), or the like.

FIG. 12 is a diagram illustrating an example of configuration of a processing circuitry 93 when the processing circuitry of the gear defect detection device 30 according to the first embodiment includes a dedicated hardware element. The processing circuitry 93 illustrated in FIG. 12 is, for example, a single circuit, a set of multiple circuits, a programmed processor, a parallel programmed processor, an application specific integrated circuit (ASIC), a field programmable gate array (FPGA), or a combination thereof. The processing circuitry 93 may be implemented partially in a dedicated hardware element and partially in software or firmware. As described above, the processing circuitry 93 can provide each functionality described above in a dedicated hardware element, software, firmware, or a combination thereof.

As described above, according to the present embodiment, the gear defect detection device 30 performs a first determination to determine the presence or absence of a defect of the gear 10 on the basis of a ratio between the length of a first time period of a first signal section and the length of a second time period of a second signal section, using a pulse signal obtained from the sensor 20, which detects top and bottom portions of the gear 10. The gear defect detection device 30 further performs a second determination to determine the presence or absence of a defect of the gear 10 by comparison of the absolute value of a first acceleration and the absolute value of a second acceleration each with the absolute value of a maximum acceleration predetermined for the railroad vehicle 40, and performs a third determination to determine the presence or absence of a defect of the gear 10 by comparison of the absolute value of a first jerk and the absolute value of a second jerk each with the absolute value of a maximum jerk predetermined for the railroad vehicle 40.

This enables the gear defect detection device 30 to increase accuracy of detection of a defect of the gear 10 that is rotating. This also enables the gear defect detection device 30 to detect a defect of the gear 10 that is not a specific type of gear such as one described in Patent Literature 1, but is the gear 10 having a general configuration. In addition, the gear defect detection device 30 is capable of detecting a defect of the gear 10 without using a sensor other than the sensor 20, another device for detecting a defect of the gear 10, or the like.

Note that the present embodiment has been described in which the gear 10 to be monitored by the gear defect detection device 30 for a defect is provided in the railroad vehicle 40, but the place of installation of the gear 10 is not limited thereto. The gear 10 to be monitored by the gear defect detection device 30 for a defect may be provided in a mobile object other than the railroad vehicle 40. Moreover, as long as the gear defect detection device 30 is aware of the amount of movement of an object that acts according to rotation of the gear 10 in association with one bottom portion of the gear 10 and in association with one top portion of the gear 10, the object that acts according to rotation of the gear 10 may be other than a mobile object such as the railroad vehicle 40. The gear defect detection device 30 can also be used for monitoring, for a defect, a gear 10 provided in, for example, a machine tool having a movable part.

In addition, the present embodiment has been described in which the gear defect detection device 30 is installed in the railroad vehicle 40, but the place of installation is not limited thereto. As long as the acquisition unit 31 can obtain a pulse signal output from the sensor 20 via wireless communication, the gear defect detection device 30 may be installed outside the railroad vehicle 40.

### Second Embodiment

In the first embodiment, the gear defect detection device 30 performs three determination methods through the first determination, the second determination, and the third determination to detect a defect of the gear 10. A second embodiment will be described with respect to a case where the gear defect detection device 30 performs a simplified operation for the determination method for detecting a defect of the gear 10.

In the second embodiment, the gear defect detection device 30 is configured similarly to the gear defect detection device 30 of the first embodiment illustrated in FIG. 1. The gear defect detection device 30 detects a defect of the gear 10 by performing the operation of the flowchart illustrated in FIG. 5. There may be a case, however, where no defect of the gear 10 has been detected, for example, for several years by the second determination method performed at step S3 or by the third determination method performed at step S4. In the first embodiment, a case has been described where the calculation unit 32 is unable to determine that the gear 10 has a defect by the first determination method at step S2, but can determine that the gear 10 has a defect by the second determination method at step S3, and a case has been described where the calculation unit 32 is unable to determine that the gear 10 has a defect by neither the first determination method at step S2 nor the second determination method at step S3, but can determine that the gear 10 has a defect by the third determination method at step S4. However, these cases may be impractical, or may be practical merely for very short time, with respect to actual running conditions of the railroad vehicle 40. In this case, the gear defect detection device 30 may omit the second determination method to be performed at step S3 or the third determination method to be performed at step S4, which enables a defect of the gear 10 to be detected at a very low frequency if at all, taking into account the processing load and/or the like.

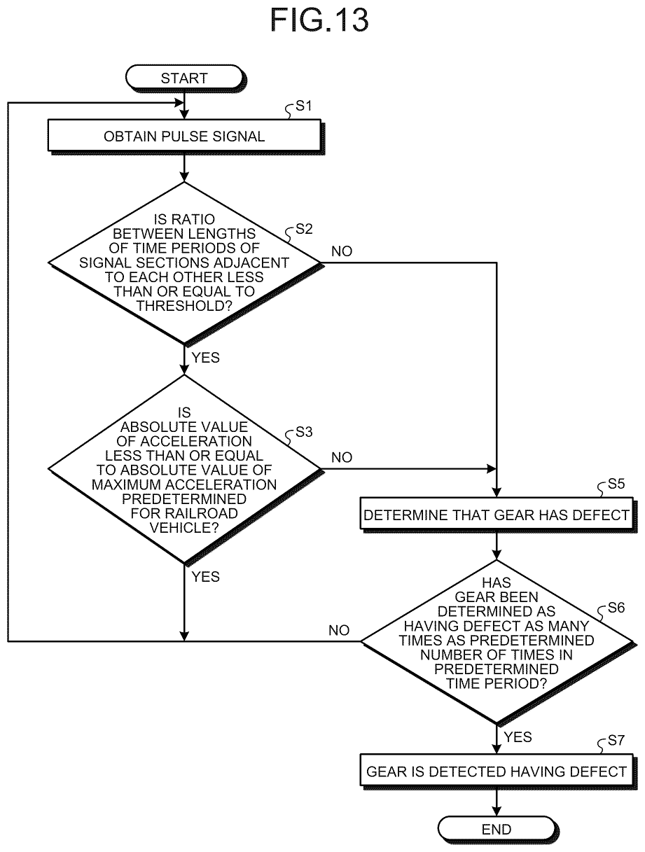

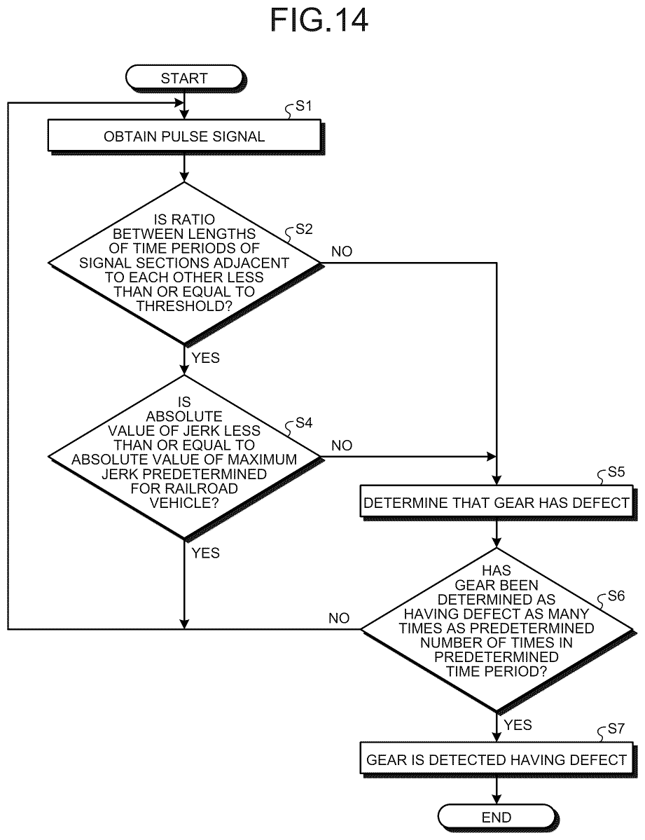

FIG. 13 is a first flowchart illustrating an operation of the gear defect detection device 30 according to the second embodiment. FIG. 14 is a second flowchart illustrating an operation of the gear defect detection device 30 according to the second embodiment. The flowchart illustrated in FIG. 13 excludes the third determination method to be performed at step S4 from the flowchart of the first embodiment illustrated in FIG. 5. The flowchart illustrated in FIG. 14 excludes the second determination method to be performed at step S3 from the flowchart of the first embodiment illustrated in FIG. 5. The operation at each step is similar to the corresponding operation of the first embodiment, and detailed description will therefore be omitted. Note, however, that due to skipping step S3 in the flowchart illustrated in FIG. 14, the calculation unit 32 of the gear defect detection device 30 needs to calculate, at step S4, the speed in each of the signal sections and the acceleration in each of the signal sections.

As described above, according to the present embodiment, the gear defect detection device 30 omits performing the third determination method at step S4 or performing the second determination method at step S3 depending on the actual performance of detection of a defect of the gear 10. This enables the gear defect detection device 30 to reduce processing load in detecting a defect of the gear 10, depending on the actual performance of detection of a defect of the gear 10.

The configurations described in the foregoing embodiments are merely examples. These configurations may be combined with another known technology, and configurations of different embodiments may be combined together. Moreover, part of such configurations may be omitted and/or modified without departing from the spirit thereof.

### REFERENCE SIGNS LIST

10 gear; 20 sensor; 30 gear defect detection device; 31 acquisition unit; 32 calculation unit; 40 railroad vehicle.

1. A gear defect detection device comprising:
an acquisition circuitry to obtain a pulse signal from a sensor for detecting top and bottom portions of a gear, the pulse signal including first signal sections and second signal sections alternating one after another, the first signal sections each representing a bottom portion of the gear, the second signal sections each representing a top portion of the gear; and
a calculation circuitry to determine, using the pulse signal, presence or absence of a defect of the gear on a basis of a ratio between a length of a first time period of a corresponding one of the first signal sections and a length of a second time period of a corresponding one of the second signal sections, and to further determine the presence or absence of a defect of the gear using at least one of acceleration or jerk of an object that acts according to rotation of the gear in the corresponding one of the first signal sections and in the corresponding one of the second signal sections by comparison of the absolute value of the acceleration with the absolute value of the maximum acceleration or comparison of the absolute value of the jerk with the absolute value of maximum jerk.

2. The gear defect detection device according to claim 1, wherein
the calculation circuitry performs a first determination to determine the presence or absence of a defect of the gear on a basis of the ratio between the length of the first time period and the length of the second time period, and
the calculation circuitry further calculates a first speed of the object in the corresponding one of the first signal sections from the length of the first time period, calculates a second speed of the object in the corresponding one of the second signal sections from the length of the second time period, calculates a first acceleration of the object in the corresponding one of the first signal sections and a second acceleration of the object in the corresponding one of the second signal sections, and performs a second determination to determine the presence or absence of a defect of the gear by comparison of an absolute value of the first acceleration and an absolute value of the second acceleration each with an absolute value of a maximum acceleration predetermined for the object, the first acceleration being a change rate of the first speed, the second acceleration being a change rate of the second speed.

3. The gear defect detection device according to claim 1, wherein
the calculation circuitry performs a first determination to determine the presence or absence of a defect of the gear on a basis of the ratio between the length of the first time period and the length of the second time period, and
the calculation circuitry further calculates a first speed of the object in the corresponding one of the first signal sections from the length of the first time period, calculates a second speed of the object in the corresponding one of the second signal sections from the length of the second time period, calculates a first acceleration of the object in the corresponding one of the first signal sections and a second acceleration of the object in the corresponding one of the second signal sections, calculates a first jerk of the object in the corresponding one of the first signal sections and a second jerk of the object in the corresponding one of the second signal sections, and performs a second determination to determine the presence or absence of a defect of the gear by comparison of an absolute value of the first jerk and an absolute value of the second jerk each with an absolute value of a maximum jerk predetermined for the object, the first acceleration being a change rate of the first speed, the second acceleration being a change rate of the second speed, the first jerk being a change rate of the first acceleration, the second jerk being a change rate of the second acceleration.

4. The gear defect detection device according to claim 1, wherein
the calculation circuitry performs a first determination to determine the presence or absence of a defect of the gear on a basis of the ratio between the length of the first time period and the length of the second time period,
the calculation circuitry further calculates a first speed of the object in the corresponding one of the first signal sections from the length of the first time period, calculates a second speed of the object in the corresponding one of the second signal sections from the length of the second time period, calculates a first acceleration of the object in the corresponding one of the first signal sections and a second acceleration of the object in the corresponding one of the second signal sections, and performs a second determination to determine the presence or absence of a defect of the gear by comparison of an absolute value of the first acceleration and an absolute value of the second acceleration each with an absolute value of a maximum acceleration predetermined for the object, the first acceleration being a change rate of the first speed, the second acceleration being a change rate of the second speed, and
the calculation circuitry still further calculates a first jerk of the object in the corresponding one of the first signal sections and a second jerk of the object in the corresponding one of the second signal sections, and performs a third determination to determine the presence or absence of a defect of the gear by comparison of an absolute value of the first jerk and an absolute value of the second jerk each with an absolute value of a maximum jerk predetermined for the object, the first jerk being a change rate of the first acceleration, the second jerk being a change rate of the second acceleration.

5. The gear defect detection device according to claim 1, wherein
when the calculation circuitry has determined that the gear has a defect using any determination method as many times as a predetermined number of times in a predetermined time period, the calculation circuitry determines that the gear has been detected having a defect.

6. A gear defect detection method for use in a gear defect detection device, the gear defect detection method comprising:
obtaining, by an acquisition circuit, a pulse signal from a sensor for detecting top and bottom portions of a gear, the pulse signal including first signal sections and second signal sections alternating one after another, the first signal sections each representing a bottom portion of the gear, the second signal sections each representing a top portion of the gear; and
determining, by a calculation circuitry, using the pulse signal, presence or absence of a defect of the gear on a basis of a ratio between a length of a first time period of a corresponding one of the first signal sections and a length of a second time period of a corresponding one of the second signal sections, and further determining, by the calculation circuitry, the presence or absence of a defect of the gear using at least one of acceleration or jerk of an object that acts according to rotation of the gear in the corresponding one of the first signal sections and in the corresponding one of the second signal sections by comparison of the absolute value of the acceleration with the absolute value of the maximum acceleration or comparison of the absolute value of the jerk with the absolute value of the maximum jerk.

7. The gear defect detection method according to claim 6, wherein
in determining the presence or absence of a defect of the gear, the calculation circuitry performs a first determination to determine the presence or absence of a defect of the gear on a basis of the ratio between the length of the first time period and the length of the second time period, and
the calculation circuitry further calculates a first speed of the object in the corresponding one of the first signal sections from the length of the first time period, calculates a second speed of the object in the corresponding one of the second signal sections from the length of the second time period, calculates a first acceleration of the object in the corresponding one of the first signal sections and a second acceleration of the object in the corresponding one of the second signal sections, and performs a second determination to determine the presence or absence of a defect of the gear by comparison of an absolute value of the first acceleration and an absolute value of the second acceleration each with an absolute value of a maximum acceleration predetermined for the object, the first acceleration being a change rate of the first speed, the second acceleration being a change rate of the second speed.

8. The gear defect detection method according to claim 6, wherein
determining the presence or absence of a defect of the gear, calculation circuitry performs a first determination to determine the presence or absence of a defect of the gear on a basis of the ratio between the length of the first time period and the length of the second time period, and
the calculation circuitry further calculates a first speed of the object in the corresponding one of the first signal sections from the length of the first time period, calculates a second speed of the object in the corresponding one of the second signal sections from the length of the second time period, calculates a first acceleration of the object in the corresponding one of the first signal sections and a second acceleration of the object in the corresponding one of the second signal sections, calculates a first jerk of the object in the corresponding one of the first signal sections and a second jerk of the object in the corresponding one of the second signal sections, and performs a second determination to determine the presence or absence of a defect of the gear by comparison of an absolute value of the first jerk and an absolute value of the second jerk each with an absolute value of a maximum jerk predetermined for the object, the first acceleration being a change rate of the first speed, the second acceleration being a change rate of the second speed, the first jerk being a change rate of the first acceleration, the second jerk being a change rate of the second acceleration.

9. The gear defect detection method according to claim 6, wherein
determining the presence or absence of a defect of the gear, the calculation circuitry performs a first determination to determine the presence or absence of a defect of the gear on a basis of the ratio between the length of the first time period and the length of the second time period,
the calculation circuitry further calculates a first speed of the object in the corresponding one of the first signal sections from the length of the first time period, calculates a second speed of the object in the corresponding one of the second signal sections from the length of the second time period, calculates a first acceleration of the object in the corresponding one of the first signal sections and a second acceleration of the object in the corresponding one of the second signal sections, and performs a second determination to determine the presence or absence of a defect of the gear by comparison of an absolute value of the first acceleration and an absolute value of the second acceleration each with an absolute value of a maximum acceleration predetermined for the object, the first acceleration being a change rate of the first speed, the second acceleration being a change rate of the second speed, and
the calculation circuitry still further calculates a first jerk of the object in the corresponding one of the first signal sections and a second jerk of the object in the corresponding one of the second signal sections, and performs a third determination to determine the presence or absence of a defect of the gear by comparison of an absolute value of the first jerk and an absolute value of the second jerk each with an absolute value of a maximum jerk predetermined for the object, the first jerk being a change rate of the first acceleration, the second jerk being a change rate of the second acceleration.

10. The gear defect detection method according to claim 6, wherein
determining the presence or absence of a defect of the gear, when the calculation circuitry has determined that the gear has a defect using any determination method as many times as a predetermined number of times in a predetermined time period, the calculation circuitry determines that the gear has been detected having a defect.

11. The gear defect detection device according to claim 2, wherein
when the calculation circuitry has determined that the gear has a defect using any determination method as many times as a predetermined number of times in a predetermined time period, the calculation circuitry determines that the gear has been detected having a defect.

12. The gear defect detection device according to claim 3, wherein
when the calculation circuitry has determined that the gear has a defect using any determination method as many times as a predetermined number of times in a predetermined time period, the calculation circuitry determines that the gear has been detected having a defect.

13. The gear defect detection device according to claim 4, wherein
when the calculation circuitry has determined that the gear has a defect using any determination method as many times as a predetermined number of times in a predetermined time period, the calculation circuitry determines that the gear has been detected having a defect.

14. The gear defect detection method according to claim 7, wherein
in determining the presence or absence of a defect of the gear, when the calculation circuitry has determined that the gear has a defect using any determination method as many times as a predetermined number of times in a predetermined time period, the calculation circuitry determines that the gear has been detected having a defect.

15. The gear defect detection method according to claim 8, wherein
in determining the presence or absence of a defect of the gear, when the calculation circuitry has determined that the gear has a defect using any determination method as many times as a predetermined number of times in a predetermined time period, the calculation circuitry determines that the gear has been detected having a defect.

16. The gear defect detection method according to claim 9, wherein
in determining the presence or absence of a defect of the gear, when the calculation circuitry has determined that the gear has a defect using any determination method as many times as a predetermined number of times in a predetermined time period, the calculation circuitry determines that the gear has been detected having a defect.
